(19) United States
(12) Patent Application Publication
(10) Pub. No.: US 2005/0209799 A1
(43) Pub. Date: Sep. 22, 2005

(54) Analysis of time-series data from an electric power-producing asset for the inference of well-defined overlapping modes (ModeMonitor)

(76) Inventors: Patryk A. Laurent, Pittsburgh, PA (US); Bradley M. Lewis, Bent Mountain, VA (US); Andrew G. Poush, Roanoke, VA (US)

Correspondence Address: THE TECHNOLOGY LAW OFFICES OF VIRGINIA, P.O. Box 818, Middleburg, VA, 20118, US

(21) Appl. No.: 11/045,622

(22) Filed: Jan. 27, 2005

Related U.S. Application Data
(60) Provisional application No. 60/540,600, filed on Jan. 29, 2004.

(51) Int. Cl. G06F 15/18

(52) U.S. Cl. 702/62

(57) ABSTRACT

This invention relates to a maximization of the inferences which are derived from data involved in data processing representing asset modes based on applicable state representations. The maximization takes place using a single algorithm to automatically analyze information and infer from electric power turbine configurations.

This application relies upon Provisional application of the exact same title as above, Ser. No. 60/540,600, filed Jan. 29, 2004 and all that is disclosed therein.

This invention is concerned with the analysis of time-series data in the electric power industry. Specifically, the data is collected from a power-producing asset For the inference of well-defined overlapping modes.

### BACKGROUND OF THE INVENTION

Essential to data processing from the assets is a consistent way to represent the asset modes based on applicable state representations. While data from assets reflect live and accurate measurements of variables from the assets, inferences generated about the status of the asset based on this data may be incorrect. The purpose of this invention is to maximize the correctness of the inferences which can be derived from the data.

### GLOSSARY

Adjustment: The value for one or more turbine controllers which should be added to an unscaled value after it has been multiplied by gain.

Alarm: A type of data which, when requested from a turbine controller for a particular turbine, returns signals consisting of symbolic alarm names, and the new state of the alarm. Alarms are different from events in that signals are received form both when the alarm is inactivated, as well as in a different way when the alarm is reset (When the situation is no longer present). Persisting alarms may also periodically be emitted. An example of an alarm is overheating, which may have critical hearing on Equivalent Hours.

Data Historian: A computer which resides on a network with turbine controllers and preserves data emitted by a particular subset of the turbines for a pre-specified duration of time. Alternatively, data historians may alternatively preserve as much information as possible due to their own storage constraints, irrespective of time duration.

Data Point: A type of data which, when requested from a turbine controller for a particular turbine AND symbolic name (for example, AMBIENT_TEMPERATURE), is provided on a periodic basis to the requesting application in the form of values. Data points are periodically polled, regardless of whether they changed, and may therefore return the same value each time if what they measure hasn't changed.

Equivalent Starts: A metric that can be used by itself or in conjunction with Equivalent Hours to predict turbine maintenance. Calculated by weighting and summing the following: number turbine starts, starting fuel, particular failures, particular trips. The present invention has a lookup table which is calibrated with the factors appropriate to each turbine type being monitored. Once Equivalent Hours has reached a certain number service/maintenance is required.

Event: A type of data which, when requested from a turbine controller for a particular turbine, returns signals consisting of symbolic alarm names, and the new Boolean (true or false) state of an event. An example of an event is Breaker Open (where an event named L52GX is true).

GE Standard Messaging (GSM): GSM is an example of a communications protocol supported by some Turbine Controllers (see Glossary) which permits sending requests for and receiving responses regarding turbine data form turbine controller. GSM messages can be sent to request data from the 3 different kings of data pathways supported by turbine controllers.

Gain: The value of one or more turbine controllers by which an unscaled data value must be multiplied by before having adjustment added to it in order to produce scaled data.

Human Machine Interface (HMI): A computer which resides on a network with turbine controllers and allows the turbine controllers to be contacted via TCP/IP.

Pathway: At least three kinds of information can be requested about turbines over the network through access to turbine controllers. The set of requests to and responses from turbine controllers, each of which includes a specific label indicating the kind of information contained, is termed a pathway. Pathways can have certain characteristics, such as buffering (where in the case of restoration after network failure, data flow is resumed from where it was left off), periodicity or event-driven.

Scaled Data: Data values which are relevant to engineers such as meters, seconds, watts, etc.

TCP/IP: A standard communications protocol, which is frequently used across the internet as well as in local area networks (LANs), which ensures that packets of data transmitted are all received at the correct destination, and in proper order.

Turbine Controller: A specialized piece of hardware that is an intermediary between the turbine's hardware and electronic systems to collect data from the turbine.

Unscaled Data: Data which are only relevant in an abstract sense to the controllers from which the data emanated; this data has no units.

### SUMMARY OF THE INVENTION

The present invention provides a single algorithm able to automatically analyze information and infer from electric power turbines of various configurations. The algorithm itself is also adaptable to other kinds of electric poser producing assets. The modes provided by the present invention are essential in bringing assets to a common denominator for uniform systematic analysis and reporting.

The method of data acquisition is not really relevant to the invention. It is only necessary that data be available to the Communication Layer from a process data server Gateway on a Plant Data Highway (PDH). The present invention makes up an important part of the Communication Layer and provides input to the Automated Run Tabulator (see Automated Run Tabulator patent). The present invention merely requires that data relevant to asset modes be provided in an accurate, automated, preferably real-time fashion. Optionally, the invention can also be used post-operationally through a database which contains a record of relevant data.

Data about asset operations is variously available through at least 3 principle data pathways: events pathway, alarms pathway and data points pathway (see Glossary). Among these 3 different pathways, there is redundancy for the most critical signals. Due to differences in the way these pathways operate, it is possible that one of these pathways is disrupted but others remain operational. In cases where a partial disruption occurs, the present invention must pool the data available to it in order to make decisions about turbine operations. The result is a device with increased reliability.

In this invention, the increased reliability is provided via a simple restatement of the same logic rules using data from the different pathways. For example, if data through the events pathway indicates that an asset has closed the generator breaker and begun generating, the mode BKRCLSD may be emitted from the invention for that turbine. However, if a temporary network disturbance prevented that event pathway data from arriving at the invention, later data through a different pathway, called the data points pathway indicating that generation has started can also trigger the mode BKRCLSD. While the timing of the BKRCLSD mode may be delayed and therefore decreased in temporal accuracy, the fact of BKRCLSD mode being recorded for that turbine is not lost, and thus the invention reaches a maximized correctness in the accuracy of inferred states. (The communications interruption is also reported, and so the invention is able to provide an accuracy measurement on the inferences provided.)

### DESCRIPTION OF THE DRAWINGS

The present invention combines a memory buffer with a propositional logic language which is suited for the assessment of event driven and periodic data from the turbine controller. ModeMonitor is tolerant of sporadic and/or irrelevant fluctuations in signals thanks to an understanding of the technical basis of the signals in the assets, the instrumentation, and the controllers (i.e. digital software logic, sequences of events, solenoids/relays.)

FIG. 1 illustrates a network in which the present invention could operate. Data is provided to the invention from the Gateway.

There are several aspects of the algorithm which are critical for faithful representations of the modes of the turbine. While data from both the events and data points pathways can activate modes, only data from the data points pathways is used to deactivate modes. This is because a timely request for data points relevant to a mode that starts is important whereas canceling the request after the mode ends is not. The ability of data points to activate or deactivate a mode is determined not just by the value of the data point being used, but by the timetag of the value. (A data point value is timetagged and stored only when the value has changed.) Thus, the present invention can exploit redundancies among various data pathways while providing insulation from the lags and inconsistencies due to their different natures.

The algorithm evaluates data according to the pathway it came from. FIG. 2 illustrates a simple example of the manner in which two pathways can cooperate and not interfere with each other. A mode will be activated when its triggering event (driven by a physical event) arrives. The corresponding data point (indicating the change in value) will arrive within one periodic cycle after the event and satisfy the data point condition for mode activation. This condition is then monitored on every periodic response. Later, when the data point condition for mode activation becomes unsatisfied, then the mode will be deactivated.

During the initiation of a mode, the conditions may fluctuate resulting in potentially costly complication in starting and stopping the flow of data several times in rapid succession resulting in data loss and/or excessive processing load on the computer network systems. Here the solution to this problem is implemented through a timer coupled to the conditions. So in these cases, mode deactivation within a certain time after the activation occurred is delayed to damp out any rapid oscillations in signal values that can occur. In effect, it behaves like a low-pass filter on the data coming from the events and data points pathways.

The algorithm is also able to handle the scenario where the data flow into the communications layer is interrupted. (For example, when a network connection is temporarily broken.) Even though the triggering event for a mode may have been lost during the time data stream was broken, the data point condition will still be evaluated and the mode activated when appropriate. This allows maximal data capture within the boundaries and limitations of the system.

### DETAILED DESCRIPTION OF THE PREFERRED EMBODIMENTS

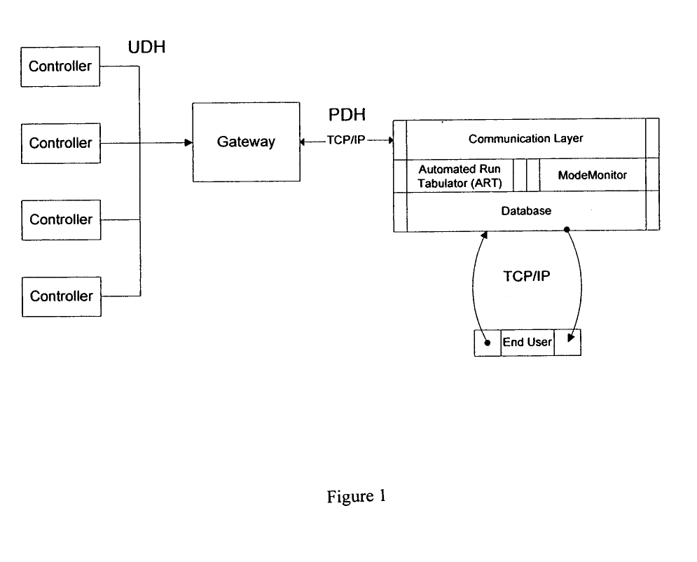

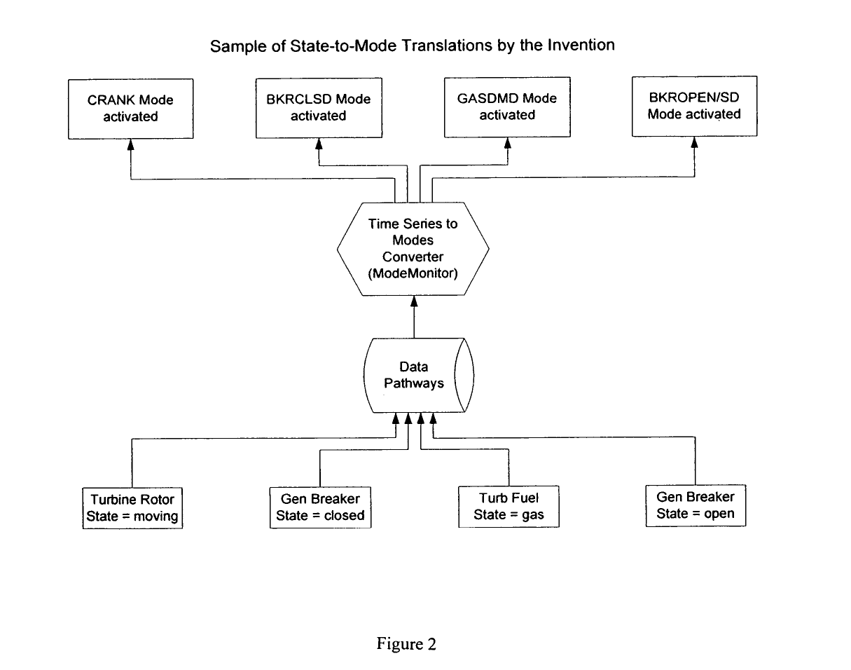

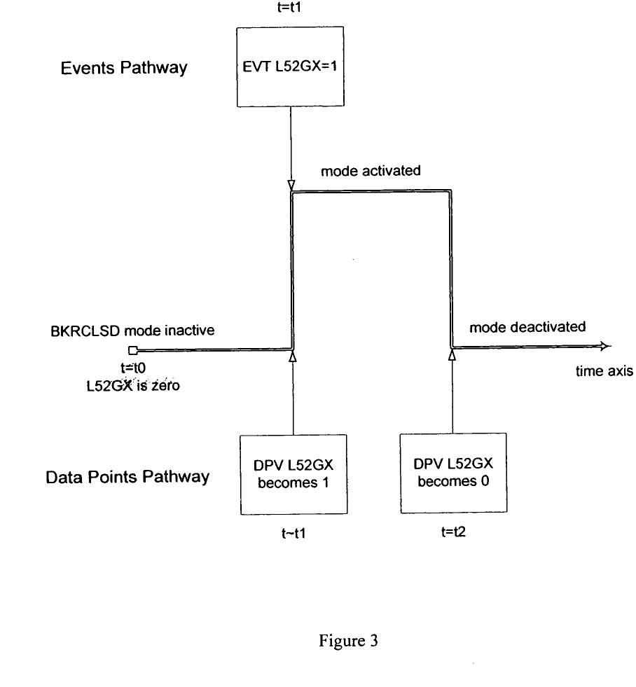

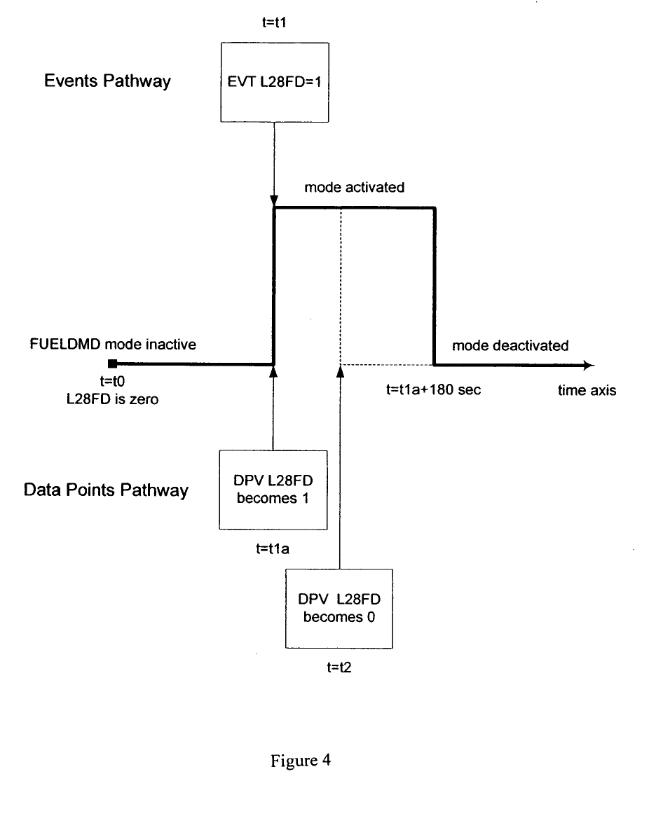

FIG. 1. Simple example network in which the present invention, “ModeMonitor”, within the Communication Layer, can operate. Arrows indicate data flow from the turbine controllers onto the Unit Data Highway (UDH). (FIG. 1 implies controllers directly connected to the UDH, but there may be PLCs or other devices interposed between the controllers and the UDH. The data on the UDH then comes through a UDH Gateway (generally a real-time HMI computer device, Data Historian computer, or other computer that can serve requests for process data) which makes the data available over a Plant Data Highway (PDH) network (using TCP/IP protocol in this example). The Communication layer (developed by SUPER natural tools, Inc.) gathers data via the PDH issuing requests to the Gateway and reading responses. (There are many variations on network topologies that cannot be shown here for the sake of brevity. The invention can be applied to any topology and take advantage of redundancies in gateways, unit and plant data highways, and controllers.)

FIG. 2. Illustration of a mechanism capable of mapping state transitions in the event and data pathways to “Modes” relevant for the function of the current invention. This Time Series to Modes Converter interprets and aggregates various on/off signals over time into continuous “Modes”. Each mode is either ON or OFF, and they reflect the simplified but most relevant situation of each turbine such as starting, generating power, and consuming fuel. This invention is completely described in another patent, submitted.

FIG. 3. Simple Illustration Example of 2-Pathway Cooperative Inference of Modes. This figure depicts redundancy (events pathway and data points pathway can activate a mode) and cooperation (where the mode deactivation logic waits until after the data point condition has been satisfied, then confirms satisfaction of the condition on every subsequent periodic response, and therefore allowing the mode to remain active). In this example, BKRCLSD mode is activated at time, t1, when its triggering event, L52GX (driven by closure of the generator breaker) arrives. The corresponding data point L52GX (having changed in value) arrives within one periodic cycle after the and satisfies the data point condition for mode activation. This condition is then monitored on every periodic response. And later, at time, t2, when the data point condition for mode activation is unsatisfied, then the mode is deactivated. Note that, as illustrated in the figure, an event cannot deactivate a mode.

FIG. 4. Further implementation of a low-pass filter for conditions governing modes. An innovation of this invention is that certain modes, subject to possible signal chatter, are not deactivated if the initiating conditions are reversed within a configurable time limit (here set at 180 seconds) following the last activation of the condition. In this figure, we illustrate this innovation in the case of the mode indicating demand for fuel (here called “FUELDMD”). The 180 seconds after time, t1a, when data point condition is satisfied, shows where changing conditions have no terminating effect on the mode. The result is improved performance and data integrity with minimal disruption to the database and other resources.

1. What is claimed is an algorithm for the analysis of time-series data from an electric power producing asset (such as a combustion chamber) in order to infer a set of well-defined modes (see Glossary) for the asset, based on event driven data (such as controller events and alarms) and periodic data (such as controller data point values polled every 30 sec.) available from the asset.

2. The system of method in [1] and a network carrying various combinations of communications protocols, such as TCP/IP, ODBC, OPC, GSM (GE Standard Messaging).

3. The system combining such a method as in [1 ] with a web-based management and information capture system which reflects up-to-date measurements and status information on turbines.

4. The system combining method [1] and a database system capable of storing data obtained through various communications protocols, which can be used to quantify data from a turbine after the operation has occurred. The modes allow periodic data to be stored selectively (that is only when it is of interest or relevant) and results in enhanced performance of the database.

5. The use of various combinations of methods and systems in [1]. [2]. [3] and [4] with many types of electric power generation including combustion turbines, aeroderivative turbines, steam turbines, hydroelectric, geothermal, wind, solar, nuclear and similar power-generating devices which produce digital and analog data related to their production of power. The modes provide a systematic basis for facilitating the automated calculation of asset performance parameters (such as fuel consumption, power production, and wear estimation of parts.)

6. A system which collects information from the systems claimed in [3], [4] and [5] from one or more turbine-holding clients with the purpose of generated comparative performance reporting among clients, where such clients may remain anonymous.
